(19) United States
(12) Patent Application Publication
(10) Pub. No.: US 2021/0173642 A1
(43) Pub. Date: Jun. 10, 2021

(54) SYSTEM AND METHOD FOR OPTIMIZING SOFTWARE QUALITY ASSURANCE DURING SOFTWARE DEVELOPMENT PROCESS

(71) Applicant: Cognizant Technology Solutions India Pvt. Ltd., Chennai (IN)

(72) Inventors: Vasanthkumar Velayudham, Plano, TX (US); Vikul Gupta, Apex, NC (US); Dattaprasad Kulkarni, Pune (IN)

(21) Appl. No.: 16/788,481

(22) Filed: Feb. 12, 2020

(30) Foreign Application Priority Data
Dec. 10, 2019 (IN) 201941050955

(51) Int. Cl. G06F 8/77; G06N 20/00

(52) U.S. Cl. CPC G06F 8/77; G06N 20/00

(57) ABSTRACT

A system and a method for optimizing software quality assurance during various phases of Software Development Process (SDP) is provided. In particular, the present invention provides for generating machine learning (ML) models corresponding to respective phases of the SDP based on historical data. Further, each of the generated ML models associated with respective phases of the SDP are configured with a set of parameters. Furthermore, a model configuration corresponding to each phase of SDP is identified by executing configured models on the historical data and a set of predefined result-parameters is analyzed. Yet further, quality assurance events are optimized by analyzing real-time data associated with respective phases of SDP using the identified model configuration corresponding to respective phases. Finally, the prediction-results of the identified model configuration are monitored for respective phases and another model configuration(s) is selected if the performance metrics of the identified model configuration are unsatisfactory.

### FIELD OF THE INVENTION

The present invention relates generally to the field of software quality assurance. More particularly, the present invention relates to a system and a method for optimizing software quality assurance during various phases of software application development process.

### BACKGROUND OF THE INVENTION

Software application development is a progressive, fast-paced and critical process, comprising multiple phases, including, but not limited to, requirement gathering and analysis, system design, coding, testing, deployment, and the like. The aforementioned phases constitute the software development life cycle (SDLC).

Various software application development methodologies have evolved in the past such as waterfall, agile, RAD (Rapid Application Development), Extreme Programming, Test Driven Development etc. In order to ensure that the application under development is developed in line with the business requirements and with business acceptable quality, the software application under development is passed through a quality assurance process corresponding to each phase of the software development life cycle (SDLC).

Existing Quality Assurance methods require a quality assurance (QA) team to review each of the phases of the SDLC and perform multiple activities such as requirement understanding, functionality validation, test automation, regression testing, DevOps integration etc. to identify and correct defects in a short duration of time. However, manual identification of defects as per conventional QA methods is time consuming and may sometime lack accuracy which may further incur cost during product roll-out. Additionally, existing QA methods require QA teams to have technical expertise to write, edit and execute test case scripts amongst other things, which in turn restricts quality assurance process for non-technical users. Yet further, existing QA methods do not work well in a real-time scenario as changes may be made frequently and manual identification of defects after each change is time consuming and costly.

In light of the above drawbacks, there is a need for a system and a method for optimizing software quality assurance during various phases of software development process. There is a need for a system and a method which automates software quality assurance. There is a need for a system and method which automates identification of defects during various phases of software development process. Further, there is a need for a system and a method which can accelerate quality assurance process based on historical data using artificial intelligence-machine learning techniques. Yet further, there is a need for a system and a method which eliminates the need for quality assurance (QA) team to have any technical expertise to perform various quality assurance activities. Yet further, there is a need for a system which can be easily integrated with any standard software development platform. Yet further, there is a need for a system and a method which enables seamless end to end development, quality assurance and deployment pipeline of software development.

### SUMMARY OF THE INVENTION

In various embodiments of the present invention, a method for optimizing software quality assurance during various phases of software development process (SDP) is provided. The method is implemented by at least one processor executing program instructions stored in a memory. The method comprises generating one or more machine learning models corresponding to respective phases of the SDP from a historical data. The historical data includes various types of data-artifacts associated with the respective phases of SDP. The method further comprises configuring each of the generated ML models associated with the respective phases of SDP with a set of variable parameters corresponding to the respective phases of SDP to generate a plurality of configured models for the respective phases of SDP. Further, the method comprises selecting a model configuration from the plurality of configured models for the respective phases of SDP for analysing real-time data associated with the respective phases of SDP based on a predefined result-parameters. Furthermore, the method comprises optimizing, events associated with quality assurance by analysing real-time data associated with the respective phases of SDP using the selected model configuration corresponding to the respective phases.

In various embodiments of the present invention, a system for optimizing software quality assurance during various phases of software development process (SDP) is provided. The system comprises a memory storing program instructions, a processor configured to execute program instructions stored in the memory, and a quality analysis engine executed by the processor. The system is configured to generate machine learning (ML) models corresponding to respective phases of the SDP from a historical data. The historical data includes various types of data-artifacts associated with the respective phases of SDP. Further, the system configures each of the generated ML models associated with the respective phases of SDP with a set of variable parameters corresponding to the respective phases of SDP to generate a plurality of configured models for the respective phases of SDP. Furthermore, the system is configured to select a model configuration from the plurality of configured models for the respective phases of SDP for analyzing real-time data associated with the respective phases of SDP based on a predefined result-parameters. Yet further, the system is configured to optimize events associated with quality assurance by analyzing real-time data associated with the respective phases of SDP using the selected model configuration corresponding to the respective phases.

In various embodiments of the present invention, a computer program product is provided. The computer program product comprises a non-transitory computer-readable medium having computer-readable program code stored thereon, the computer-readable program code comprising instructions that, when executed by a processor, cause the processor to generate machine learning models corresponding to respective phases of the SDP from a historical data. The historical data includes various types of data-artifacts associated with the respective phases of SDP. Further, each of the generated ML models associated with the respective phases of SDP are configured with a set of variable parameters corresponding to the respective phases of SDP to generate a plurality of configured models for the respective phases of SDP. Furthermore, a model configuration from the plurality of configured models is selected for the respective phases of SDP for analyzing real-time data associated with the respective phases of SDP based on a predefined result-parameters. Yet further, events associated with quality assurance are optimized by analyzing real-time data associated with the respective phases of SDP using the selected model configuration corresponding to the respective phases.

### BRIEF DESCRIPTION OF THE ACCOMPANYING DRAWINGS

The present invention is described by way of embodiments illustrated in the accompanying drawings wherein:

FIG. 1 illustrates a block diagram of a system for optimizing software quality assurance during various phases of software development process, in accordance with various embodiments of the present invention;

FIG. 2 is a flowchart illustrating a method for optimizing software quality assurance during various phases of software development process, in accordance with various embodiments of the present invention; and

FIG. 3 illustrates an exemplary computer system in which various embodiments of the present invention may be implemented.

### DETAILED DESCRIPTION OF THE INVENTION

The present invention discloses a system and a method for optimizing software quality assurance during various phases of Software Development Process (SDP). In particular, the present invention provides for generating one or more machine learning (ML) models corresponding to respective phases of the SDP based on historical data. The historical data may be associated with at least one of: application under development (AUT), other related applications having common software modules, unrelated applications having common software modules and the like. Further, the present invention, provides for configuring each of the generated one or more ML models associated with respective phases of the SDP with a set of parameters corresponding to respective phases of the SDP. Yet further, a model configuration corresponding to each phase of SDP is identified by executing the configured models on the historical data and analyzing a set of predefined result-parameters. The present invention further provides for optimizing events associated with quality assurance by analyzing real-time data associated with respective phases of SDP using the identified model configuration corresponding to respective phases. Finally, the present invention provides for monitoring the prediction-results of the identified model configuration corresponding to respective phases and selecting another model configuration(s) if the performance metrics of the identified model configuration are unsatisfactory.

The disclosure is provided in order to enable a person having ordinary skill in the art to practice the invention. Exemplary embodiments herein are provided only for illustrative purposes and various modifications will be readily apparent to persons skilled in the art. The general principles defined herein may be applied to other embodiments and applications without departing from the spirit and scope of the invention. The terminology and phraseology used herein is for the purpose of describing exemplary embodiments and should not be considered limiting. Thus, the present invention is to be accorded the widest scope encompassing numerous alternatives, modifications and equivalents consistent with the principles and features disclosed herein. For purposes of clarity, details relating to technical material that is known in the technical fields related to the invention have been briefly described or omitted so as not to unnecessarily obscure the present invention. The terms result-parameters and performance metrics in the specification have been used interchangeable.

The present invention would now be discussed in context of embodiments as illustrated in the accompanying drawings.

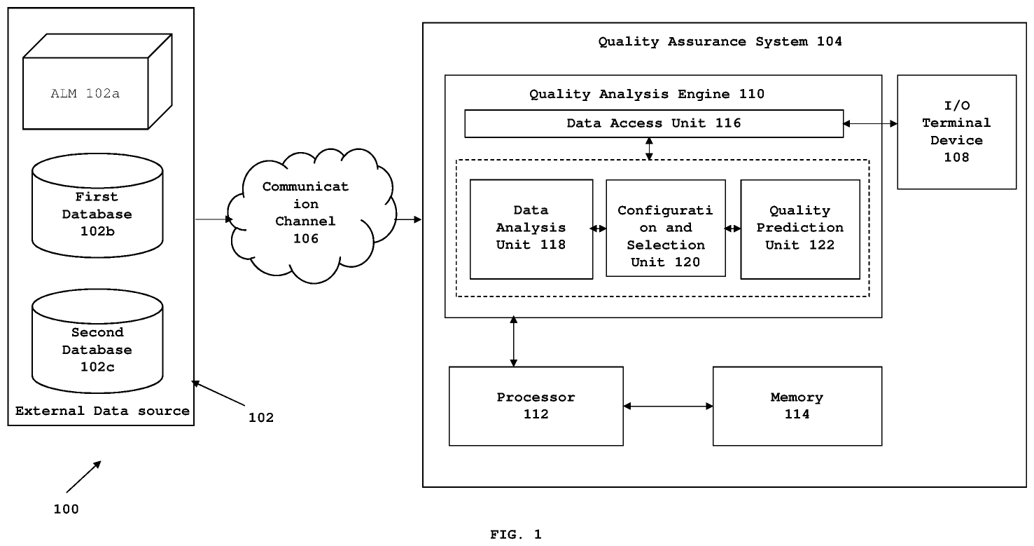

FIG. 1 illustrates a block diagram of a system for optimizing software quality assurance during various phases of software development process, in accordance with various embodiments of the present invention.

Referring to FIG. 1, in an embodiment of the present invention, the system 100 comprises a DevOps platform 102, an application delivery management subsystem 104 and a terminal device 106.

Referring to FIG. 1, in an embodiment of the present invention, an environment 100 for optimizing software quality assurance during various phases of Software Development Process (SDP) is illustrated. In various embodiments of the present invention, the environment 100 comprises an external data source 102 and a system for optimizing software quality assurance during various phases of Software Development Process (SDP) hereinafter referred to as quality assurance system 104.

In various embodiments of the present invention, the external data source 102 comprises a collection of historical data and real-time data in one or more databases maintained in the same or separate storage servers. In an embodiment of the present invention, the historical data and the real-time data may be associated with at least one of: application under development (AUT), other related applications having common software modules, unrelated applications having common software modules and the like. In an embodiment of the present invention, the external data source 102 may be an enterprise database configured to collect historical data associated with the application under development (AUT) and the plurality of previously developed applications and real-time data associated with the application under development (AUT) during various phases of software development process (SDP). The phases of SDP also referred to as Software Development Lifecycle (SDLC) may include, but are not limited to, requirement gathering and analysis, system design, coding, testing, deployment, and the like. In an embodiment of the present invention, as shown in FIG. 1, the external data source 102 includes an Application Lifecycle Management system (ALM) 102a, a first database 102b and a second database 102c to maintain historical data and real-time data associated with various phases of SDP. In an exemplary embodiment of the present invention, examples of ALM system may include, but are not limited to HP ALM, JIRA, Rally, Service Now etc. In an exemplary embodiment of the present invention, the first database 102b and the second database 102c may be selected from Subversion, Git, Apache Server logs etc. In an exemplary embodiment of the present invention, the historical data may include various types of data-artifacts collected during respective phases of SDP. Examples of data artifacts may include, but are not limited to, user stories, defects, test cases, test execution logs, SCM logs, server logs, performance logs, incident tickets, social network feed etc.

In various embodiments of the present invention, the quality assurance system 104 may be a hardware, software or a combination of hardware and software. In an embodiment of the present invention as shown in FIG. 1, the quality assurance system 104 is a combination of hardware and software. The quality assurance system 104 is configured as a platform and interfaces with the external data source 102 to retrieve the historical data and the real-time data over a communication channel 106. Examples of the communication channel 106 may include, but are not limited to, an interface such as a software interface, a physical transmission medium, such as, a wire, or a logical connection over a multiplexed medium, such as, a radio channel in telecommunications and computer networking. Examples of radio channel in telecommunications and computer networking may include, but are not limited to, a Local Area Network (LAN), a Metropolitan Area Network (MAN), and a Wide Area Network (WAN). In another embodiment of the present invention, the quality assurance system 104 may be a software component integrated with the application lifecycle management system 102a (ALM).

In another embodiment of the present invention, the quality assurance system 104 may be implemented as a client-server architecture, wherein one or more application developers access a server hosting the quality assurance system 104 over a communication channel (not shown).

In yet another embodiment of the present invention, the quality assurance system 104 may be implemented in a cloud computing architecture in which data, applications, services, and other resources are stored and delivered through shared data-centers. In an exemplary embodiment of the present invention, the functionalities of the quality assurance system 104 are delivered as software as a service (SAAS).

In an embodiment of the present invention as shown in FIG. 1, the quality assurance system 104 comprises an input/output (I/O) terminal device 108, a quality analysis engine 110, at least one processor 112 and a memory 114. The quality analysis engine 110 is operated via the processor 112 specifically programmed to execute instructions stored in the memory 114 for executing functionalities of the system 104 in accordance with various embodiments of the present invention. Examples of the input/output (I/O) terminal device 108 may include, but are not limited to, a touchscreen display, a keyboard and a display combination or any other wired or wireless device capable of receiving inputs and displaying output results.

In various embodiments of the present invention, the quality analysis engine 110 is a self-learning engine configured to receive complex datasets, analyze datasets, extract patterns of data-artifacts, generate and configure models from the extracted patterns, identify optimized model configuration, and analyze real-time data optimize quality assurance. In various embodiments of the present invention, the quality analysis engine 110 has multiple units which work in conjunction with each other for detecting anomalous patterns in a network. The various units of the quality analysis engine 110 are operated via the processor 112 specifically programmed to execute instructions stored in the memory 114 for executing respective functionalities of the multiple units in accordance with various embodiments of the present invention. In an embodiment of the present invention, the memory 114 may be divided into random access memory (RAM) and Read-only memory (ROM). In an embodiment of the present invention, the quality analysis engine 110 comprises a data access unit 116, a data analysis unit 118, a configuration and selection unit 120 and a quality prediction unit 122.

The data access unit 116 is configured to interface with the external data source 102 and the I/O terminal device 108. The data access unit 116 is configured to interface with the external data source 102 to retrieve historical data and real-time data associated with various phases of SDP over the communication channel 106. The data access unit 116 is configured to parse the retrieved data into structured, semi-structured and unstructured data using one or more parsing techniques. In an exemplary embodiment of the present invention, the parsing techniques are regular expression based and/or Grok pattern based parsing techniques. In another embodiment of the present invention, the data access unit 116 is integrated with one or more data parsing modules such as Logstash and Talend ESB to parse the retrieved historical data and real-time data. In an embodiment of the present invention, the data access unit 116 communicates with the I/O terminal device 108 to receive one or more inputs and transmit results.

In an embodiment of the present invention, the data analysis unit 118 is configured to receive the parsed historical data and real-time data associated with various phases of SDP from the data access unit 116. As already described above in the specification, the historical data and the real-time data include various types of data-artifacts collected during respective phases of SDP. Examples of data artifacts may include, but are not limited to, user stories, defects, test cases, test execution logs, SCM logs, server logs, performance logs, incident tickets, social network feed etc. The data analysis unit 118 is configured to analyze the parsed historical data to identify a general pattern of defects associated with respective phases of SDP. In particular, complex technical details for the end user are abstracted from the historical data to jump start model execution. Further, the data analysis unit 118 is configured to generate one or more machine learning (ML) models corresponding to respective phases of the SDP based on analyzed historical data. The data analysis unit 118, uses one or more machine learning techniques to generate the one or more ML models. Examples of machine learning techniques may include, but are not limited to, text processing, classification, regression, clustering etc. In operation, the analyzed data is processed. In an exemplary embodiment of the present invention, data processing comprises tokenization, stop word removal, stemming, vectorization, dimensionality reduction. Further the processed data is used for building ML models. The one or more machine learning (ML) models are generated to identify defects associated with respective phases of SDP. In an exemplary embodiment of the present invention, the ML models are generated for identifying data artifacts associated with at least one of the following phases: requirement gathering and analysis, system design, coding, testing, deployment, and the like. In various embodiments of the present invention, the historical data may be associated with at least one of: application under development (AUT), other related applications having common software modules, unrelated applications having common software modules and the like.

In an embodiment of the present invention, the configuration and selection unit 120 is configured to receive the one or more ML models associated with respective phases of SDP from the data analysis unit 118. The configuration and selection unit 120 is configured to configure each of the generated one or more ML models associated with respective phases of the SDP with a set of parameters corresponding to respective phases of the SDP. In operation, each ML model is executed iteratively with different set of parameters to build the most accurate ML model. In an embodiment of the present invention, the set of parameters may include, but is not limited to, duration of historical data with which the ML models have been trained; filters on the priority of data; text processing based parameters such as RegEx pattern, Stopwords, ngram configuration, vectorization related parameters; hyper parameters of algorithms such as random forest, Naïve Bayes, K-Means clustering etc. In another embodiment of the present invention, the configuration and selection unit 120 is configured to receive one or more parameters from a user via I/O terminal device 108.

The configuration and selection unit 120 is further configured to select a model configuration corresponding to each phase of SDP for analyzing real-time data associated with respective phases of SDP. In operation, the configuration and selection unit 120 selects a model configuration corresponding to each phase of SDP by executing the configured models on the historical data and analyzing a set of predefined result-parameters. A model configuration for respective phase of SDP is selected by the configuration and selection unit 120, if said configuration satisfies the predefined result-parameters values. In an exemplary embodiment of the present invention, the predefined result-parameters may include, but are not limited to, model accuracy, model f1-score, precision, recall, cluster quality score etc. In another embodiment of the present invention, the configuration and selection unit 120 provides a model selection option for manual selection of one or more model configuration corresponding to each phase of SDP via the I/O terminal device 108.

In an embodiment of the present invention, the quality prediction unit 122 is configured to receive the selected model configuration corresponding to each phase of SDP from the configuration and selection unit 120. The quality prediction unit 122 is configured to optimize events associated with quality assurance by analyzing real-time data associated with respective phases of SDP using the selected model configuration corresponding to respective phases. In operation, the quality prediction unit 122 is configured to receive real-time data from the external data source 102 via the data access unit 116. The quality prediction unit 122 is configured to parse the real-time data via the data analysis unit 118. Further, the quality prediction unit 122 is configured to identify the phase of SDP associated with the real-time data. The quality prediction unit 122 analyzes the real-time data using the selected model configuration corresponding to the identified phase of SDP and identifies data artifacts associated with the phase of SDP. Examples of data artifacts associated with various phases of SDP may include, but are not limited to, defects in user stories, requirements, test cases; failures in test cases, duplicate test cases. In an embodiment of the present invention, events associated with quality assurance may include, but are not limited to, performing risk based testing, pruning and optimizing defect backlogs, predicting number of defects, predicting success percentage of test cases, identifying frequently failing test cases, identifying gaps in testing process, test optimization, triage effort optimization, defect turnaround time improvement, identifying frequent defects etc.

In an embodiment of the present invention, the quality prediction unit 122 is configured to monitor the prediction-results of the selected (identified) model configuration corresponding to respective phases. The quality prediction unit 122 analyses predefined performance metrics associated with each of the selected model configurations implemented on real-time data. In an embodiment of the present invention, each model configuration has respective set of performance metrics to ascertain performance. The set of performance metrics are selected based on the machine learning technique used for generating the corresponding ML model. In an exemplary embodiment of the present invention, the predefined performance metrics may include, but are not limited to, model accuracy, model f1-score, precision, recall, Silhouette score etc. The quality prediction unit 122 deploys the selected model configurations identified for respective phases of SDP for analyzing real-time data in live environment if the performance metrics are satisfactory and continuously upgrades said model configurations for further use. The quality prediction unit 122 is configured to re-evaluate and select one or more other model configuration(s) if the performance metrics of the identified model configuration(s) are unsatisfactory and dips below a predefined threshold for performance metrics.

Advantageously, the Quality assurance system 104 of the present invention analyzes historical data, extracts intelligence from historical data and applies the extracted intelligence on the real-time data to optimize software quality assurance. Further, the system of the present invention allows various user to measure performance of the ML models without technical complexities.

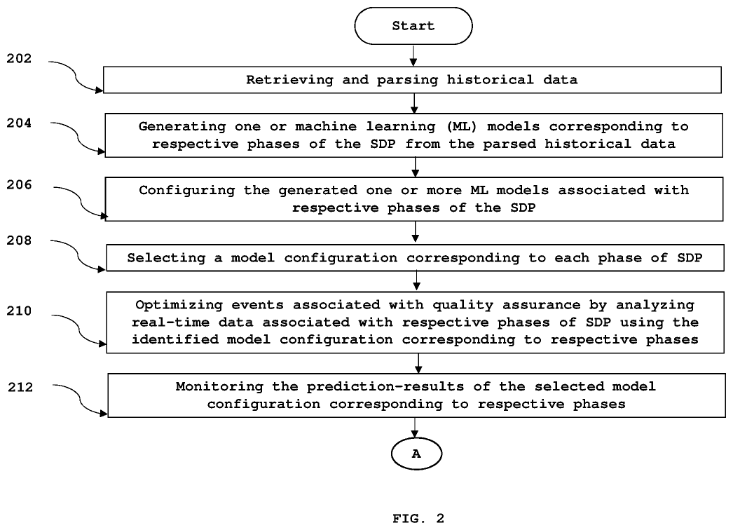

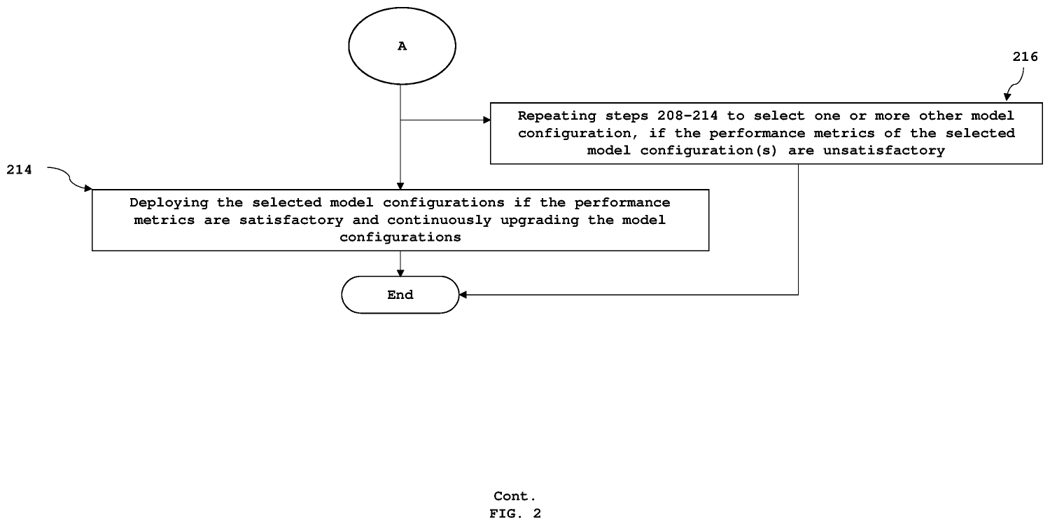

FIG. 2 is a flowchart illustrating a method for optimizing software quality assurance during various phases of software development process, in accordance with various embodiments of the present invention; and

At step 202, historical data is retrieved and parsed. In an embodiment of the present invention, historical data associated with various phases of SDP is retrieved from an external data source (102 of FIG. 1) over a communication channel (106 of FIG. 1). In various embodiments of the present invention, the historical data may be associated with at least one of: application under development (AUT), other related applications having common software modules, unrelated applications having common software modules and the like. In an exemplary embodiment of the present invention, the historical data may include various types of data-artifacts collected during respective phases of SDP in the past. Examples of data artifacts may include, but are not limited to, user stories, defects, test cases, test execution logs, SCM logs, server logs, performance logs, incident tickets, social network feed etc. The retrieved data may include structured, semi-structured and unstructured data type. The retrieved data is parsed using one or more parsing techniques. In various embodiments of the present invention, the one or more parsing techniques may be selected based on the data type retrieved from the external data source. In an exemplary embodiment of the present invention, the one or more parsing techniques may be selected from regular expression based and/or Grok pattern based parsing techniques. In another embodiment of the present invention, the retrieved data is parsed via one or more data parsing modules such as Logstash and Talend ESB. In an exemplary embodiment of the present invention, Logstash is used to parse unstructured data and Talend is used to parse semi-structured and unstructured data.

At step 204, one or more machine learning (ML) models corresponding to respective phases of SDP are generated from the parsed historical data. In an embodiment of the present invention, the parsed historical data is analyzed to identify a general pattern of defects associated with respective phases of SDP. In particular, complex technical details for the end user are abstracted from the historical data to jump start model execution. Further, one or more machine learning (ML) models corresponding to the respective phases of SDP are generated based on the analyzed historical data. The one or more machine learning (ML) models are generated using one or more machine learning techniques. Examples of machine learning techniques may include, but are not limited to, text processing, classification, regression, clustering etc. In operation, the analyzed data is processed. In an exemplary embodiment of the present invention, data processing comprises tokenization, stop word removal, stemming, vectorization, dimensionality reduction. Further the processed data is used for building ML models. The one or more machine learning (ML) models are generated to identify defects associated with respective phases of SDP. In an exemplary embodiment of the present invention, the ML models are generated for optimizing events associated with quality assurance by analyzing defects in at least one of the following phases: requirement gathering and analysis, system design, coding, testing, deployment, and the like.

At step 206, each of the generated ML models associated with respective phases of the SDP are configured. In an embodiment of the present invention, each of the generated one or more ML models associated with respective phases of the SDP are configured with a set of variable parameters corresponding to respective phases of the SDP to generate a plurality of configured models for the respective phases. In an embodiment of the present invention, the set of parameters may include, but is not limited to, duration of collection of historical data; filters on the priority of data; text processing based parameters such as RegEx pattern, Stop words, ngram configuration, vectorization related parameters; hyper parameters of algorithms such as random forest, Naïve Bayes, K-Means clustering etc. In another embodiment of the present invention, the one or more parameters may be received manually from a user via an I/O terminal device (108 of FIG. 1).

At step 208, a model configuration corresponding to each phase of SDP is selected. In an embodiment of the present invention, a model configuration corresponding to each phase of SDP is selected from the plurality of configured models for analyzing real-time data associated with respective phases of SDP. In operation, a model configuration corresponding to each phase of SDP is selected by iteratively executing each of the configured models on the historical data and analyzing a set of predefined result-parameters. A model configuration for respective phase of SDP is selected, if said configuration satisfies the predefined result-parameter values. In an exemplary embodiment of the present invention, the predefined result-parameters may include, but are not limited to, model accuracy, model f1-score, precision, recall, cluster quality score etc. In another embodiment of the present invention, a model configuration corresponding to each phase of SDP maybe manually selected via the I/O terminal device (108 of FIG. 1).

At step 210, events associated with quality assurance are optimized by analyzing real-time data associated with respective phases of SDP using the selected model configuration corresponding to respective phases. In operation, real-time data associated with one or more phases of SDP is received from the external data source 102. The real-time data is parsed using one or more parsing techniques. In various embodiments of the present invention, the one or more parsing techniques may be selected based on the data type retrieved from the external data source, such as structured, semi-structured and unstructured data. In an exemplary embodiment of the present invention, the one or more parsing techniques may be selected from regular expression based and/or Grok pattern based parsing techniques. Further, the phase of SDP associated with the real-time data is identified. The received real-time data is analyzed using the selected model configuration corresponding to the identified phase of SDP and data artifacts associated with the respective phase of SDP are identified. Examples of data artifacts associated with various phases of SDP may include, but are not limited to, defects in user stories, requirements, test cases; failures in test cases, duplicate test cases. In an embodiment of the present invention, events associated with quality assurance may include, but are not limited to, performing risk based testing, pruning and optimizing defect backlogs, predicting number of defects, predicting success percentage of test cases, identifying frequently failing test cases, identifying gaps in testing process, test optimization, triage effort optimization, defect turnaround time improvement, identifying frequent defects etc.

At step 212, prediction-results of the selected model configuration corresponding to respective phases is monitored. In an embodiment of the present invention, predefined performance metrics associated with each of the selected model configurations implemented on real-time data are analyzed. In an embodiment of the present invention, each model configuration has respective set of performance metrics to ascertain performance. The set of performance metrics are selected based on the machine learning technique used for generating the corresponding ML model. In an exemplary embodiment of the present invention, the predefined performance metrics may include, but are not limited to, model accuracy, model f1-score, precision, recall, Silhouette score etc.

At step 214, the selected model configurations identified for respective phases of SDP are deployed for analyzing real-time data in live environment if the performance metrics are satisfactory, and continuously upgraded for further use. At step 216, one or more other model configuration(s) are selected by repeating steps 208-214, if the performance metrics of the identified model configuration(s) are unsatisfactory and dips below a predefined threshold of performance metrics.

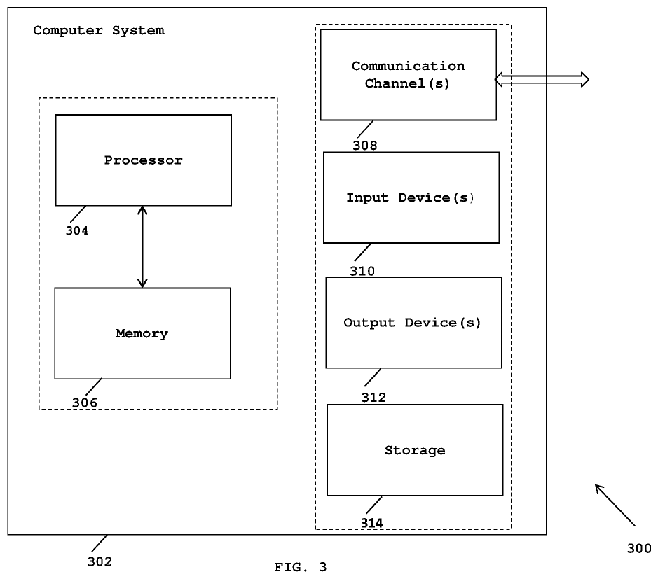

FIG. 3 illustrates an exemplary computer system in which various embodiments of the present invention may be implemented. The computer system 302 comprises a processor 304 and a memory 306. The processor 304 executes program instructions and is a real processor. The computer system 302 is not intended to suggest any limitation as to scope of use or functionality of described embodiments. For example, the computer system 302 may include, but not limited to, a programmed microprocessor, a micro-controller, a peripheral integrated circuit element, and other devices or arrangements of devices that are capable of implementing the steps that constitute the method of the present invention. In an embodiment of the present invention, the memory 306 may store software for implementing various embodiments of the present invention. The computer system 302 may have additional components. For example, the computer system 302 includes one or more communication channels 308, one or more input devices 310, one or more output devices 312, and storage 314. An interconnection mechanism (not shown) such as a bus, controller, or network, interconnects the components of the computer system 302. In various embodiments of the present invention, operating system software (not shown) provides an operating environment for various softwares executing in the computer system 302, and manages different functionalities of the components of the computer system 302.

The communication channel(s) 308 allow communication over a communication medium to various other computing entities. The communication medium provides information such as program instructions, or other data in a communication media. The communication media includes, but not limited to, wired or wireless methodologies implemented with an electrical, optical, RF, infrared, acoustic, microwave, Bluetooth or other transmission media.

The input device(s) 310 may include, but not limited to, a keyboard, mouse, pen, joystick, trackball, a voice device, a scanning device, touch screen or any another device that is capable of providing input to the computer system 302. In an embodiment of the present invention, the input device(s) 310 may be a sound card or similar device that accepts audio input in analog or digital form. The output device(s) 312 may include, but not limited to, a user interface on CRT or LCD, printer, speaker, CD/DVD writer, or any other device that provides output from the computer system 302.

The storage 314 may include, but not limited to, magnetic disks, magnetic tapes, CD-ROMs, CD-RWs, DVDs, flash drives or any other medium which can be used to store information and can be accessed by the computer system 302. In various embodiments of the present invention, the storage 314 contains program instructions for implementing the described embodiments.

The present invention may suitably be embodied as a computer program product for use with the computer system 302. The method described herein is typically implemented as a computer program product, comprising a set of program instructions which is executed by the computer system 302 or any other similar device. The set of program instructions may be a series of computer readable codes stored on a tangible medium, such as a computer readable storage medium (storage 314), for example, diskette, CD-ROM, ROM, flash drives or hard disk, or transmittable to the computer system 302, via a modem or other interface device, over either a tangible medium, including but not limited to optical or analogue communications channel(s) 308. The implementation of the invention as a computer program product may be in an intangible form using wireless techniques, including but not limited to microwave, infrared, Bluetooth or other transmission techniques. These instructions can be preloaded into a system or recorded on a storage medium such as a CD-ROM, or made available for downloading over a network such as the internet or a mobile telephone network. The series of computer readable instructions may embody all or part of the functionality previously described herein.

The present invention may be implemented in numerous ways including as a system, a method, or a computer program product such as a computer readable storage medium or a computer network wherein programming instructions are communicated from a remote location.

While the exemplary embodiments of the present invention are described and illustrated herein, it will be appreciated that they are merely illustrative. It will be understood by those skilled in the art that various modifications in form and detail may be made therein without departing from or offending the spirit and scope of the invention.

We claim:

1. A method for optimizing software quality assurance during various phases of software development process (SDP), wherein the method is implemented by at least one processor executing program instructions stored in a memory, the method comprising:
generating, by the processor, one or more machine learning models corresponding to respective phases of the SDP from a historical data, wherein the historical data includes various types of data-artifacts associated with the respective phases of SDP;
configuring, by the processor, each of the generated ML models associated with the respective phases of SDP with a set of variable parameters corresponding to the respective phases of SDP to generate a plurality of configured models for the respective phases of SDP;
selecting, by the processor, a model configuration from the plurality of configured models for the respective phases of SDP for analyzing real-time data associated with the respective phases of SDP based on a predefined result-parameters; and
optimizing, by the processor, events associated with quality assurance by analyzing real-time data associated with the respective phases of SDP using the selected model configuration corresponding to the respective phases.

2. The method as claimed in claim 1, wherein prediction-results obtained by analyzing real-time data via the selected model configuration corresponding to the respective phases of SDP are monitored based on a predefined performance metrics associated with the selected model configuration, and another model configuration is selected if the performance metrics of the selected model configuration is unsatisfactory or dips below a predefined threshold of the performance metrics.

3. The method as claimed in claim 1, wherein the historical data is associated with at least one of: application under development (AUT), other related applications having common software modules, and unrelated applications having common software modules, further wherein the historical data may include structured, semi-structured and unstructured data type.

4. The method as claimed in claim 1, wherein generating the machine learning models corresponding to the respective phases of the SDP comprises:
parsing the historical data using one or more parsing techniques, wherein the one or more parsing techniques may be selected based on a data type in the historical data;
analyzing the parsed historical data to identify a general pattern of defects associated with the respective phases of SDP and abstracting complex technical details by analyzing the parsed historical data; and
generating one or more machine learning (ML) models corresponding to the respective phases of SDP based on the analyzed historical data using one or more machine learning techniques.

5. The method as claimed in claim 4, wherein the one or more parsing techniques may be selected from at least one of a regular expression based technique and a Grok pattern based parsing technique.

6. The method as claimed in claim 4, wherein the one or more machine learning techniques may be selected from at least one of: text processing, classification, regression, and clustering.

7. The method as claimed in claim 1, wherein the phases of software development process (SDP) include requirement gathering and analysis, system design, coding, testing, and deployment.

8. The method as claimed in claim 1, wherein each of the generated one or more machine learning models are configured with the set of variable parameters corresponding to the respective phases of SDP.

9. The method as claimed in claim 1, wherein the variable set of parameters include duration of collection of historical data, filters on the priority of data, text processing based parameters including: RegEx pattern, Stopwords, ngram configuration and vectorization parameters, and hyper parameters of algorithms including random forest, Naïve Bayes and K-Means clustering.

10. The method as claimed in claim 1, wherein selecting the model configuration for the respective phases of SDP comprises iteratively executing each of the plurality of configured models corresponding to each phase of SDP on the historical data, and analyzing the set of predefined result-parameters, wherein the model configuration showing closest proximity with the predefined result-parameter values are selected for the respective phases.

11. The method as claimed in claim 1, wherein the predefined result parameters include model accuracy, model f1-score, precision, recall, and cluster quality score.

12. The method as claimed in claim 1, wherein optimizing the events associated with quality assurance comprises:
parsing the real-time data using one or more parsing techniques;
identifying the phases of SDP associated with the real-time data; and
analyzing the parsed real-time data using the selected model configuration associated with the identified phases of SDP to identify data artifacts associated with the identified phases of SDP to optimize quality assurance.

13. The method as claimed in claim 1, wherein events associated with quality assurance include performing risk based testing, pruning and optimizing defect backlogs, predicting number of defects, predicting success percentage of test cases, identifying frequently failing test cases, identifying gaps in testing process, test optimization, triage effort optimization, defect turnaround time improvement, and identifying frequent defects.

14. A system for optimizing software quality assurance during various phases of software development process (SDP), the system comprising:
a memory storing program instructions; a processor configured to execute program instructions stored in the memory; and a quality analysis engine executed by the processor to:
generate machine learning (ML) models corresponding to respective phases of the SDP from a historical data, wherein the historical data includes various types of data-artifacts associated with the respective phases of SDP;
configure each of the generated ML models associated with the respective phases of SDP with a set of variable parameters corresponding to the respective phases of SDP to generate a plurality of configured models for the respective phases of SDP;
select a model configuration from the plurality of configured models for the respective phases of SDP for analyzing real-time data associated with the respective phases of SDP based on a predefined result-parameters; and
optimize events associated with quality assurance by analyzing real-time data associated with the respective phases of SDP using the selected model configuration corresponding to the respective phases.

15. The system as claimed in claim 14, wherein prediction-results obtained by analyzing real-time data via the selected model configuration corresponding to the respective phases of SDP are monitored based on a predefined performance metrics associated with the selected model configuration, and another model configuration is selected if the performance metrics of the selected model configuration is unsatisfactory or dips below a predefined threshold of the performance metrics.

16. The system as claimed in claim 14, wherein the historical data is associated with at least one of:
application under development (AUT), other related applications having common software modules, and unrelated applications having common software modules, further wherein the historical data may include structured, semi-structured and unstructured data type.

17. The system as claimed in claim 14, wherein the quality analysis engine comprises a data analysis unit in communication with the processor, said data analysis unit configured to generate the machine learning models corresponding to the respective phases of the SDP by:
parsing the historical data using one or more parsing techniques, wherein the one or more parsing techniques may be selected based on a data type in the historical data;
analyzing the parsed historical data to identify a general pattern of defects associated with the respective phases of SDP and abstracting complex technical details by analyzing the parsed historical data; and
generating one or more machine learning (ML) models corresponding to the respective phases of SDP based on the analyzed historical data using one or more machine learning techniques.

18. The system as claimed in claim 17, wherein the one or more parsing techniques may be selected from at least one of a regular expression based technique and a Grok pattern based parsing technique.

19. The system as claimed in claim 17, wherein the one or more machine learning techniques may be selected from at least one of: text processing, classification, regression, and clustering.

20. The system as claimed in claim 14, wherein the phases of software development process (SDP) include requirement gathering and analysis, system design, coding, testing, and deployment.

21. The system as claimed in claim 14, wherein the quality analysis engine comprises a configuration and selection unit in communication with the processor, said configuration and selection unit configured to configure each of the generated one or more machine learning models with the set of variable parameters corresponding to the respective phases of SDP.

22. The system as claimed in claim 14, wherein the variable set of parameters include duration of collection of historical data, filters on the priority of data, text processing based parameters including: RegEx pattern, Stopwords, ngram configuration and vectorization parameters, and hyper parameters of algorithms including random forest, Naïve Bayes and K-Means clustering.

23. The system as claimed in claim 14, wherein the quality analysis engine comprises a configuration and selection unit in communication with the processor, said configuration and selection unit configured to select the model configuration for the respective phases of SDP by iteratively executing each of the plurality of configured models corresponding to each phase of SDP on the historical data, and analyzing the set of predefined result-parameters, wherein the model configuration showing closest proximity with the predefined result-parameter values are selected for the respective phases.

24. The system as claimed in claim 14, wherein the predefined result parameters include model accuracy, model f1-score, precision, recall, and cluster quality score.

25. The system as claimed in claim 14, wherein the quality analysis engine comprises a quality prediction unit in communication with the processor, said quality prediction unit configured to optimize the events associated with quality assurance by:
parsing the real-time data using one or more parsing techniques;
identifying the phases of SDP associated with the real-time data; and
analyzing the parsed real-time data using the selected model configuration associated with the identified phases of SDP to identify data artifacts associated with the identified phases of SDP to optimize quality assurance.

26. The system as claimed in claim 14, wherein events associated with quality assurance include performing risk based testing, pruning and optimizing defect backlogs, predicting number of defects, predicting success percentage of test cases, identifying frequently failing test cases, identifying gaps in testing process, test optimization, triage effort optimization, defect turnaround time improvement, and identifying frequent defects.

27. A computer program product comprising:
a non-transitory computer-readable medium having computer-readable program code stored thereon, the computer-readable program code comprising instructions that, when executed by a processor, cause the processor to:
generate machine learning models corresponding to respective phases of the SDP from a historical data, wherein the historical data includes various types of data-artifacts associated with the respective phases of SDP;
configure each of the generated ML models associated with the respective phases of SDP with a set of variable parameters corresponding to the respective phases of SDP to generate a plurality of configured models for the respective phases of SDP;
select a model configuration from the plurality of configured models for the respective phases of SDP for analyzing real-time data associated with the respective phases of SDP based on a predefined result-parameters; and
optimize events associated with quality assurance by analyzing real-time data associated with the respective phases of SDP using the selected model configuration corresponding to the respective phases.
